(19) United States
(12) Patent Application Publication
(10) Pub. No.: US 2021/0294165 A1
(43) Pub. Date: Sep. 23, 2021

(54) DISPLAY PANEL AND DISPLAY DEVICE

(71) Applicant: TCL CHINA STAR OPTOELECTRONICS TECHNOLOGY CO., LTD., Shenzhen, Guangdong (CN)

(72) Inventor: Zixiang ZHANG, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 16/980,408

(22) PCT Filed: Apr. 2, 2020
(86) PCT No.: PCT/CN2020/082921

§ 371 Date: Sep. 13, 2020

(30) Foreign Application Priority Data
Mar. 18, 2020 (CN) 202010191370.3

(51) Int. Cl. G02F 1/1362; G02F 1/1343; G02F 1/1335

(52) U.S. Cl. CPC G02F 1/136209; G02F 1/134345; G02F 1/136286; G02F 2201/122; G02F 2201/123; G02F 1/133514

(57) ABSTRACT

A display panel and a display device are provided. The display panel is provided with a circuit layer, a pixel layer disposed on the circuit layer. The pixel layer includes a plurality of sub-pixels, and a first gap is formed between two of the sub-pixels adjacent to each other with different colors. The circuit layer includes a plurality of shielding parts, and one of the shielding parts corresponds to the first gap.

### FIELD OF INVENTION

The present disclosure relates to a display technical field, and specifically, to a display panel and a display device.

### BACKGROUND OF INVENTION

A vertical alignment panel, as a liquid crystal display (LCD) panel, has high contrast and color gamut saturation.

In current VA panels, a black matrix is disposed on a color filter substrate to shield gaps between sub-pixels of different colors on an array substrate. However, when the color filter substrate is assembled with the array substrate, it is difficult to align the black matrix to the corresponding gaps. The black matrix cannot completely shield the gaps of the sub-pixels of different colors on the array substrate, which causes a light leakage between the gaps and decreases the contrast of the display panel.

It is therefore necessary to provide a display panel and a display device capable of improving a contrast.

### SUMMARY OF DISCLOSURE

### Technical Problem

The present disclosure provides a display panel and a display device provided with a plurality of shielding parts below a pixel layer, and each of the shielding parts corresponds to a gap between two of the sub-pixels adjacent to each other having different colors to completely shield the gap, thereby solving the problem that an existing black matrix on the color filter substrate incompletely shields the gap after the color filter substrate is assembled with the array substrate, resulting in poor contrast of the display panel.

### Technical Solutions

The present disclosure provides a display panel, comprising a circuit layer, a pixel layer disposed on the circuit layer, and a color filter substrate disposed on one side of the pixel layer away from the circuit layer; wherein

the pixel layer comprises a plurality of sub-pixels, a first gap is formed between two of the sub-pixels adjacent to each other having different colors, and each of the sub-pixels includes a first main electrode splitting said one of the sub-pixels;

the circuit layer comprises a plurality of shielding parts and a plurality of data lines, one of the shielding parts corresponds to the first gap, and each of the data lines is aligned to the first main electrode of the sub-pixels corresponding to the data lines; and

the color filter substrate comprises a plurality of color resist blocks with different colors, the color resist blocks correspond to the sub-pixels, a third gap is formed between two of the color resist blocks adjacent to each other, and a width of one of the shielding parts is greater than a width of the first gap and a width of the third gap corresponding to said one of the shielding parts.

In some embodiments, each of the sub-pixels comprises a first sub-pixel portion and a second sub-pixel portion, a second gap is formed between the first sub-pixel portion and the second sub-pixel portion, and one of the shielding parts corresponds to the second gap.

In some embodiments, a width of one of the shielding parts is greater than a width of the second gap corresponding to said one of the shielding parts.

In some embodiments, each of the sub-pixels comprises a main electrode splitting said one of the sub-pixels, and the shielding parts corresponds to the main electrode.

In some embodiments, a width of one of the shielding parts is greater than a width of the main electrode corresponding to said one of the shielding parts.

In some embodiments, a material of the shielding parts is an opaque metal.

In some embodiments, each of the sub-pixels further comprises a first branch electrode and a second branch electrode disposed on two sides of the first main electrode, the first branch electrode and the second branch electrode both comprise a plurality of sub-branch electrodes, wherein an arrangement direction of the sub-branch electrodes of the first branch electrode is different from an arrangement direction of the sub-branch electrodes of the second branch electrode.

In some embodiments, each of the sub-pixels further comprises a second main electrode, the second main electrode and the first main electrode are cross-arranged with each other, and the second main electrode split said one of the sub-pixels; and

the circuit layer further comprises a plurality of gate lines, each of the gate lines controls multiple of the sub-pixels, each of the gate lines is aligned to the second main electrode of the sub-pixels corresponding to said one of the gate lines.

The present disclosure further provides a display panel, comprising a circuit layer, and a pixel layer disposed on the circuit layer; wherein

the pixel layer comprises a plurality of sub-pixels, a first gap is formed between two of the sub-pixels adjacent to each other having different colors; and

the circuit layer comprises a plurality of shielding parts, and one of the shielding parts corresponds to the first gap.

In some embodiments, the display panel further comprises:

a color filter substrate disposed on one side of the pixel layer away from the circuit layer, wherein the color filter substrate comprises a plurality of color resist blocks with different colors, the color resist blocks correspond to the sub-pixels, a third gap is formed between two of the color resist blocks adjacent to each other with different colors, and a width of one of the shielding parts is greater than a width of the first gap and a width of the third gap corresponding to said one of the shielding parts.

In some embodiments, each of the sub-pixels comprises a first sub-pixel portion and a second sub-pixel portion, a second gap is formed between the first sub-pixel portion and the second sub-pixel portion, and one of the shielding parts corresponds to the second gap.

In some embodiments, a width of one of the shielding parts is greater than a width of the second gap corresponding to said one of the shielding parts.

In some embodiments, each of the sub-pixels comprises a main electrode splitting said one of the sub-pixels, and one of the shielding parts corresponds to the main electrode.

In some embodiments, a width of one of the shielding parts is greater than a width of the main electrode corresponding to said one of the shielding parts.

In some embodiments, a material of the shielding parts is an opaque metal.

In some embodiments, each of the sub-pixels comprises a first main electrode splitting said one of the sub-pixels; and

the circuit layer further comprises a plurality of data lines, each of the data lines controls multiple of the sub-pixels, and each of the data lines is aligned to the first main electrode of the multiple of the sub-pixels corresponding to said one of the data lines.

In some embodiments, each of the sub-pixels further comprises a first branch electrode and a second branch electrode disposed on two sides of the first main electrode, the first branch electrode and the second branch electrode both comprise a plurality of sub-branch electrodes, wherein an arrangement direction of the sub-branch electrodes of the first branch electrode is different from an arrangement direction of the sub-branch electrodes of the second branch electrode.

In some embodiments, each of the sub-pixels further comprises a second main electrode, the second main electrode and the first main electrode are cross-arranged with each other, and the second main electrode splits said one of the sub-pixels; and

the circuit layer further comprises a plurality of gate lines, each of the gate lines controls multiple of the sub-pixels, each of the gate lines is aligned to the second main electrode of the sub-pixels corresponding to said one of the gate lines.

The present disclosure further provides a display device comprising a display panel which is provided with a circuit layer, and a pixel layer disposed on the circuit layer; wherein

the pixel layer comprises a plurality of sub-pixels, and a first gap is formed between two of the sub-pixels adjacent to each other having different colors; and

the circuit layer comprises a plurality of shielding parts, one of the shielding parts corresponds to the first gap.

In some embodiments, each of the sub-pixels comprises a first main electrode splitting said one of the sub-pixels; and

the circuit layer further comprises a plurality of data lines, each of the data lines controls multiple of the sub-pixels, each of the data lines is aligned to the first main electrode of the sub-pixels corresponding to said one of the data lines.

Beneficial Effect:

The beneficial effect of the present disclosure is that the display panel and the display device provided by the embodiments of the present disclosure comprise a circuit layer and a pixel layer disposed on the circuit layer; wherein the pixel layer comprises a plurality of sub-pixels, a first gap is formed between two of the sub-pixels adjacent to each other having different colors; and the circuit layer comprises a plurality of shielding parts, one of the shielding parts corresponds to the first gap. By using the shielding parts corresponding to the gaps between the adjacent sub-pixels having different colors and disposed below the pixel layer, even in the later stage of assembling the color filter substrate with the array substrate, since the shielding parts and the pixel layer are both disposed on the array substrate, the shielding parts are not movable and still completely shield the gaps, so as to improve the contrast of the display panel.

### BRIEF DESCRIPTION OF DRAWINGS

The present disclosure is further explained below with the accompanying drawings. It is noted that the drawings described below are merely some embodiments of the present disclosure, and it will be possible to those skilled in the art to obtain other drawings according to these drawings without creative efforts.

FIG. 1 is a cross-sectional view of a display panel according to one embodiment of the present disclosure.

FIG. 2 is a schematic view of a first display panel according to one embodiment of the present disclosure.

FIG. 3 is a schematic view of a second display panel according to one embodiment of the present disclosure.

FIG. 4 is a schematic view of a third display panel according to one embodiment of the present disclosure.

FIG. 5 is a schematic view of a fourth display panel according to one embodiment of the present disclosure.

FIG. 6 is a schematic view of a fifth display panel according to one embodiment of the present disclosure.

FIG. 7 is a schematic view of a sixth display panel according to one embodiment of the present disclosure.

### DETAILED DESCRIPTION OF PREFERRED EMBODIMENTS

The technical solutions in embodiments of the present disclosure are described clearly and completely in combination with the accompany drawings according to the embodiments of the present disclosure. Apparently, the described embodiments are merely a part of the embodiments of the present disclosure, and not all of the embodiments. Based on the embodiment in the present disclosure, all other embodiments obtained by those skilled in the art without creative efforts are within the protection scope of the present disclosure.

In the description of the present disclosure, it should be understood that the terms “longitudinal”, “lateral”, “width”, “upper”, “lower”, “vertical”, “horizontal”, “between”, “opposite”, etc., for indicating orientation or position are based on the orientation or position shown in the drawings, which are merely for the convenience of describing the present disclosure and simplifying the description, rather than for indicating or implying that the devices or elements referred to must have a specific orientation or should be constructed and operated with specific position, and thus cannot be understood as a limitation of the present disclosure. Moreover, the terms “first” and “second” are used for description only, and cannot be understood as indicating or implying relative importance, or the number of technical features indicated. Thus, features defined as “first” and “second” may explicitly or implicitly include one or more of the features. In the description of the present disclosure, “multiple” means two or more than two, unless it is specifically defined.

In the present disclosure, unless explicitly stated and limited, the description of the first feature “above” or “below” the second feature may include direct contact between the first feature and second features, or may include indirect contact through another feature between the first feature and second features. Moreover, the first feature “above”, “on” and “over” the second feature means that the first feature is directly above and obliquely above the second feature, or simply means that the first feature is located at a position higher than a position where the second feature is located at.

The following disclosure provides many different embodiments or examples for implementing different structures of the present disclosure. For simplify the present disclosure, the components and configuration of the specific embodiment are described below. Of course, they are only examples, and the purpose is not to limit the present disclosure. Moreover, the present disclosure may repeat reference numbers and/or reference letters in different examples. This repetition is for simplicity and clarity, and does not in itself indicate the relationship between the various embodiments and/or configurations discussed.

The present disclosure provides a display panel, and the display panel includes but is not limited to embodiments as shown in FIGS. 1-7.

In one embodiment, as shown in FIG. 1, the display panel 00 comprises a circuit layer 100 and a pixel layer 200 disposed on the circuit layer 100. It can be understood that a substrate 300 is provided below the circuit layer 100. The substrate 300 may be a glass substrate or any other transparent substrate.

In one embodiment, a backlight module may be provided below the substrate 300. The backlight module is used for providing the display panel 00 a light. The light passes through the substrate 300, the circuit layer 100 and the pixel layer 200 to form a display image. It can be understood that a liquid crystal layer may be disposed on the pixel layer 200. The liquid crystal layer includes a plurality of liquid crystal molecules. The liquid crystal molecules may be arranged according to a patterned electrode pattern of the pixel layer 200 and form a pretilt angle.

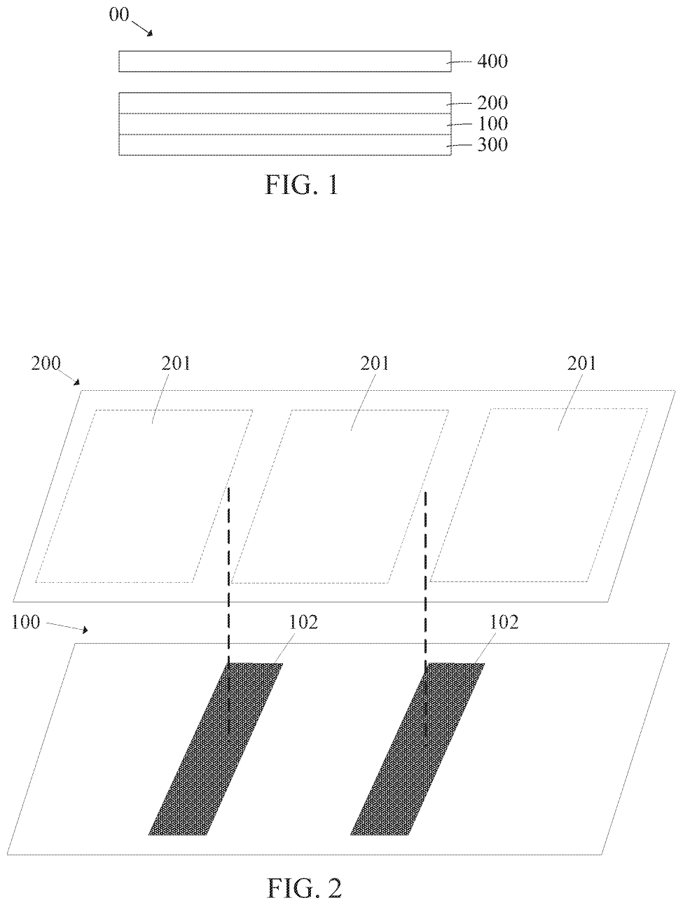

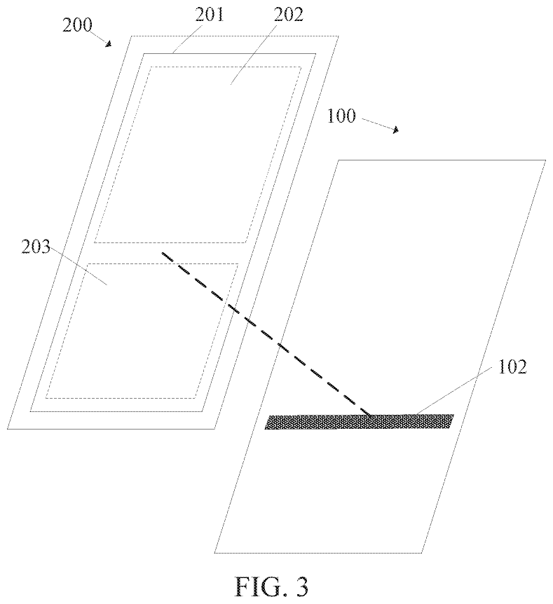

In one embodiment, as shown in FIG. 2, the pixel layer 200 comprises a plurality of sub-pixels 201, a first gap is formed between two of the sub-pixels 201 adjacent to each other having different colors. The circuit layer 100 comprises a plurality of shielding parts 102. One of the shielding parts 102 corresponds to the first gap.

It can be understood that, as shown in FIG. 1, the display panel further comprises a color filter substrate 400 disposed on one side of the pixel layer 200 away from the circuit layer, and the color filter substrate 400 corresponds to the pixel layer 200. The color filter substrate 400 comprises a plurality of color resist blocks with different colors. The color resist blocks correspond to the sub-pixels 201. A third gap is formed between two of the color resist blocks adjacent to each other. In the prior art, a black color block disposed on the color filter substrate 400 corresponds to the first gap for shielding the first gap to reduce light leakage. However, the color filter substrate 400 and the pixel layer are prepared separately, so that it is difficult for the black color block to be aligned to the gap between the two sub-pixels 201 adjacent to each other in the later assembly process. Furthermore, in this disclosure, since the shielding parts 102 are disposed below the pixel layer 200, there is no displacement problem caused by the later assembling process. Therefore, the present disclosure can solve the light leakage of the first gap in the dark state to increase the contrast of the display panel 00. In addition, the black color block in the prior art can be omitted to save materials for preparing the display panel 00 and shorten the period of preparing the display panel 00.

Furthermore, because the shielding parts 102 are merely used for shielding the region between the two sub-pixels 201 adjacent to each other, but rather for transmitting any signal, the shielding parts 102 do not affect the electronic signals of the two sub-pixels 201 adjacent to each other. Therefore, in order to ensure that the shielding parts 102 can completely shield the first gap and the third gap corresponding to the shielding parts, a width of one of the shielding parts 102 is greater than a width of the first gap and a width of the third gap corresponding to said one of the shielding parts 102.

In one embodiment, as shown in FIG. 3, each of the sub-pixels 201 comprises a first sub-pixel portion 202 and a second sub-pixel portion 203, a second gap is formed between the first sub-pixel portion 202 and the second sub-pixel portion 203, and one of the shielding parts 102 corresponds to the second gap. Here, take the top and bottom arrangement of the first sub-pixel portion 202 and the second sub-pixel portion 203 in the same one of the sub-pixels 201 as an example.

It can be understood that the second gap would be provided with thin film transistor elements and relevant devices having poor transmittance, which causes poor light transmittance within the second gap, but the problem of light leakage still occurs in the dark state. For the same reason, the shielding parts 102 disposed on the circuit layer 100 within the region corresponding to the second gap may increase the contrast of the display panel 00. Similarly, a width of one of the shielding parts 102 is greater than a width of the second gap corresponding to said one of the shielding parts.

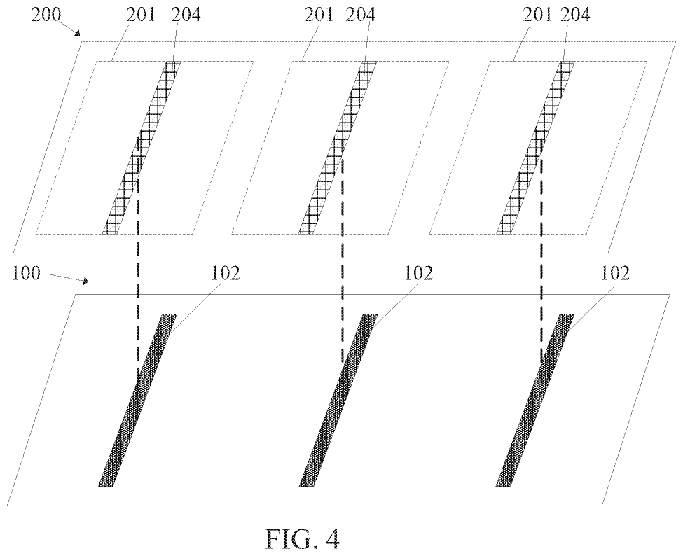

In one embodiment, as shown in FIG. 4, each of the sub-pixels 201 comprises a main electrode 204 splitting said one of the sub-pixels 201, and the shielding parts 102 correspond to the main electrode 204.

The main electrode 204 may be arranged in a lateral, a longitudinal, or other direction. Herein, the main electrode 204 arranged in a longitudinal direction is taken as an example. It can be understood that, in original situation, the electrode patterns located on two side of the main electrode 204 are cross-arranged with the main electrode 204, and the electrode patterns located on two sides of the main electrode 204 are also cross-arranged with each other. Therefore, during image displayduring image display, dark fringe may appear at positions corresponding to the main electrode 204. For the same reason, the shielding parts 102 disposed on the circuit layer 100 within the region corresponding to the main electrode 204 may increase the contrast of the display panel 00. Similarly, a width of one of the shielding parts 102 is greater than a width of the main electrode 204 corresponding to said one of the shielding parts.

In one embodiment, a material of the shielding parts 102 may be a shielding material. Furthermore, a material of the shielding parts 102 may be an opaque metal. That is, the shielding parts 102 may be produced in the same layer together with the structure of the circuit layer 100 which is formed of metals to prevent from increasing period of preparing the display panel 00.

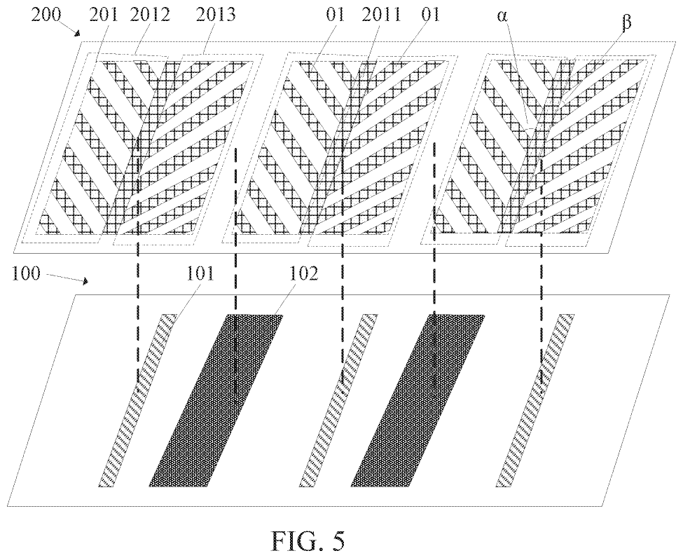

In one embodiment, as shown in FIG. 5, each of the sub-pixels 201 includes a first main electrode 2011 splitting said one of the sub-pixels 201; the circuit layer 100 further comprises a plurality of data lines 101, each of the data lines 101 controls multiple of the sub-pixels 201, and each of the data lines 101 is aligned to the first main electrode 2011 of the sub-pixels 201 corresponding to said one of the data lines 101. For the setting method of the first main electrode 2011, please refer to the relevant description of the main electrode 204 above. Therefore, during image display, during image displaydark fringe may appear at positions corresponding to the first main electrode 2011. For the same reason, the data lines 101 disposed on the circuit layer 100 within the region corresponding to the first main electrode 2011 may increase the contrast of the display panel 00. Furthermore, compared with the arrangement of the data lines 101 between two of the sub-pixels 201 in the prior art, the electronic signal of the data lines 101 in this embodiment does not disturb the signal between two of the sub-pixels 201 adjacent to each other. It is possible to reduce a distance between the two sub-pixels 201 to increase a transmittance of the display panel 00 for a light passed therethrough.

In one embodiment, as shown in FIG. 5, each of the sub-pixels 201 further comprises a first branch electrode 2012 and a second branch electrode 2013 disposed on two sides of the first main electrode 2011, the first branch electrode 2012 and the second branch electrode 2013 both comprise a plurality of sub-branch electrodes 01, wherein an arrangement direction of the sub-branch electrodes 01 of the first branch electrode 2012 is different from an arrangement direction of the sub-branch electrodes 01 of the second branch electrode 2013.

It is characterized that the sub-branch electrodes 01 of the first branch electrode 2012 and the second branch electrode 2013 may be arranged in parallel to or be cross-arranged with each other, and just make sure that the arrangement direction of the sub-branch electrodes 01 of the first branch electrode 2012 is different from the arrangement direction of the sub-branch electrodes 01 of the second branch electrode 2013.

It can be noted that, since the arrangement direction of the sub-branch electrodes 01 of the first branch electrode 2012 is different from the arrangement direction of the sub-branch electrodes 01 of the second branch electrode 2013, when the display panel 00 is working, the orientations of the liquid crystal molecules on the first branch electrode 2012 and the second branch electrode 2013 are inconsistent, and the dark fringes are formed within the region corresponding to the first main electrode 2011 during image display. In this embodiment, the data lines 101 correspond to the first main electrode 2011, so that the original display effect of the region corresponding to the first main electrode 2011 is not affected. However, compared with the arrangement of the data lines 101 between two of the sub-pixels 201 in the prior art, the electronic signal of the data lines 101 in this embodiment does not disturb the signal between two of the sub-pixels 201 adjacent to each other. It is possible to reduce a distance between the two sub-pixels 201 to increase a transmittance of the display panel 00 for a light passing therethrough.

In one embodiment, as shown in FIG. 5, the sub-branch electrodes 01 of the first branch electrode 2012 and the second branch electrode 2013 may be arranged in parallel to each other. It can be understood that the liquid crystal molecules on the first branch electrode 2012 may form a pretilt angle along the same direction. Under an electric field, the interaction force between the liquid crystal molecules on the first branch electrode 2012 and the second branch electrode 2013 contributes to the orientation of the liquid crystal molecules and increase the transmittance of the light in the liquid crystal molecules on the first branch electrode 2012 or the second branch electrode 2013.

Furthermore, as shown in FIG. 5, the angle between the sub-branch electrodes 01 of the first branch electrode 2012 and the second branch electrode 2013 and the first main electrode 2011 corresponding to the sub-branch electrodes 01 is an acute angle or an obtuse angle. It can be understood that the liquid crystal molecules on the first branch electrode 2012 and the second branch electrode 2013 have different pretilt angles, and later, the liquid crystal molecules may rotate along the corresponding pretilt angles. During the final image display, the dependency of the viewing angle is improved. Furthermore, the angle α between the sub-branch electrodes 01 of the first branch electrode 2012 and the first main electrode 2011 corresponding to the sub-branch electrodes 01 may be equal to the angle β between the sub-branch electrodes 01 of the second branch electrode 2013 and the first main electrode 2011 corresponding to the sub-branch electrodes 01. It can be understood that when the angle α is equal to the angle β, the symmetry of the viewing angle of the display panel 00 is increased. For example, upon viewing the screen along the arrangement direction of the sub-branch electrodes 01 of the first branch electrode 2012 and along the arrangement direction of the sub-branch electrodes 01 of the second branch electrode 2013, the displayed image is observed in the same extent. Specifically, the angle α and the angle β may be 45°.

Further, as shown in FIG. 5, the first branch electrode 2012 and the second branch electrode 2013 may be symmetrical about the corresponding first main electrode 2011. It can be understood that the first branch electrode 2012 and the second branch electrode 2013 have the same size. That is, the arrangement and size of the sub-branch electrodes 01 on two sides of the first main electrode 2011 are completely consistent, so as to further improve the symmetry of the viewing able of the display panel 00.

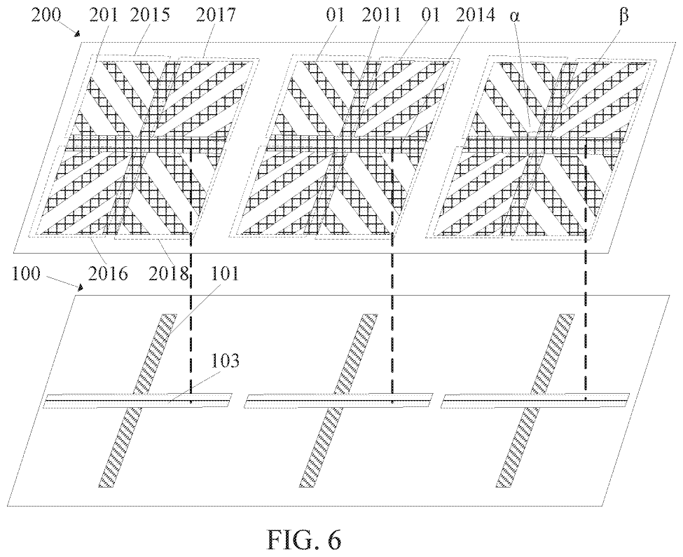

In one embodiment, as shown in FIG. 6, the sub-pixels 201 further comprises a second main electrode 2014 cross-arranged with the first main electrode 2011. The first branch electrode 2012 is divided into a third branch electrode 2015 and a fourth branch electrode 2016 by the second main electrode 2014. The second branch electrode 2013 is divided into a fifth branch electrode 2017 and a sixth branch electrode by the second main electrode 2014. Here, take the second main electrode 2014 perpendicular to and equally dividing the first main electrode 2011 as an example. It can be understood that when the first branch electrode 2012 and the second branch electrode 2013 are symmetrical with respect to the corresponding first main electrode 2011, the third branch electrode 2015, the fourth branch electrode 2016, the fifth branch electrode 2017, and the sixth branch electrode 2018 have the same area.

It should be noted that an arrangement direction of the sub-branch electrodes 01 of the third branch electrode 2015 is different from an arrangement direction of the sub-branch electrodes 01 of the fourth branch electrode 2016. An arrangement direction of the sub-branch electrodes 01 of the fifth branch electrode 2017 is different from an arrangement direction of the sub-branch electrodes 01 of the fourth branch electrode 2018.

Specially, the circuit layer 100 further comprises a plurality of gate lines 103. Each of the gate lines 103 controls multiple of the sub-pixels 201. Each of the gate lines 103 corresponds to the second main electrode 2014 of the sub-pixels corresponding to said one of the gate lines.

It can be noted that, since the arrangement direction of the sub-branch electrodes 01 of the first branch electrode 2012 is different from the arrangement direction of the sub-branch electrodes 01 of the second branch electrode 2013, the arrangement direction of the sub-branch electrodes 01 of the third branch electrode 2015 is different from the arrangement direction of the sub-branch electrodes 01 of the fourth branch electrode 2016, and the arrangement direction of the sub-branch electrodes 01 of the fifth branch electrode 2017. However, the arrangement direction of the sub-branch electrodes 01 of the fourth branch electrode 2016 may be same as the arrangement direction of the sub-branch electrodes 01 of the fifth branch electrode 2017. As shown in FIG., the sub-branch electrodes 01 of any adjacent branch electrode of each of the sub-pixels 201 may be symmetrical with respect to the corresponding main electrode and finally present a “*” shape.

Certainly, the sub-branch electrodes 01 of each of the branch electrodes are arranged in parallel to or cross-arranged with each other, and just make sure that the arrangement direction of the sub-branch electrodes 01 of the first branch electrode 2012 is different from the arrangement direction of the sub-branch electrodes 01 of the second branch electrode 2013, the arrangement direction of the sub-branch electrodes 01 of the third branch electrode 2015 s different from the arrangement direction of the sub-branch electrodes 01 of the fourth electrode 2016, and the arrangement direction of the sub-branch electrodes 01 of the fifth branch electrode 2017 is different from the arrangement direction of the sub-branch electrodes 01 of the sixth electrode 2018.

Similarly, compared with the arrangement of the data lines 101 between two of the sub-pixels 201 in the prior art, the electronic signal of the data lines 101 in this embodiment does not disturb the signal between two of the sub-pixels 201 adjacent to each other. It is possible to reduce a distance between the two sub-pixels 201 to increase a transmittance of the display panel 00 for a light passed therethrough.

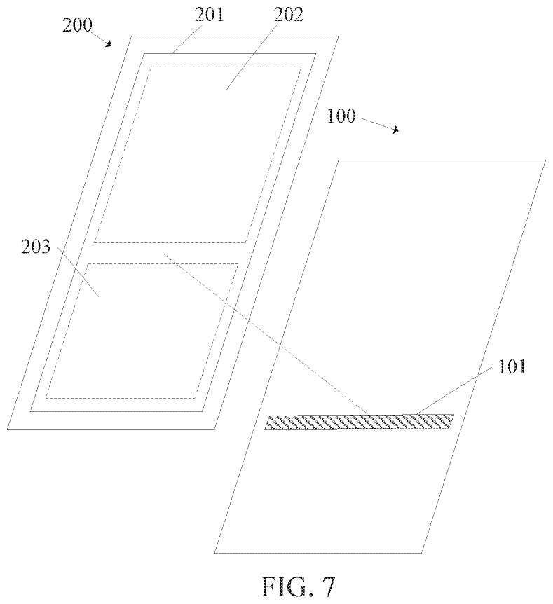

In one embodiment, as shown in FIG. 7, the difference between FIG. 7 and FIG. 3 is that the data lines 101 or the gate lines 103 may be disposed correspondingly to the second gap. Here, the data lines 101 disposed correspondingly to the second gap is taken as an example.

It can be understood that the second gap would be provided with thin film transistor elements and relevant devices having poor transmittance which causes poor light transmittance within the second gap, but the problem of light leakage still occurs in the dark state. For the same reason, the gate lines 103 disposed on the circuit layer 100 within the region corresponding to the second gap may increase the contrast of the display panel 00. In addition, compared with the arrangement of the data lines 101 between two of the sub-pixels 201 in the prior art, the signal of the data lines 101 in this embodiment does not disturb the signal between two of the sub-pixels 201 adjacent to each other. It is possible to reduce a distance between the two sub-pixels 201 to increase a transmittance of the display panel 00 for a light passed therethrough.

The present disclosure also provides a display device comprising any abovementioned display panel.

In above embodiments, the description of each embodiment has its own emphasis. For parts that are not described in detail in an embodiment, please refer to the relevant description of other embodiments.

The display panel and the display device provided by the embodiments of the present disclosure comprise a circuit layer and a pixel layer disposed on the circuit layer; wherein the pixel layer comprises a plurality of sub-pixels, a first gap is formed between two of the sub-pixels adjacent to each other having different colors; and the circuit layer comprises a plurality of shielding parts, one of the shielding parts corresponds to the first gap. By using the shielding parts which correspond to the gaps between the adjacent sub-pixels having different colors and disposed below the pixel layer, even in the later stage of assembling the color filter substrate with the array substrate, since the shielding parts and the pixel layer are both disposed on the array substrate, the shielding parts are not movable and still completely shield the gaps, so as to improve the contrast of the display panel.

The display panel and the display device provided by the embodiments of the present disclosure are described in detail above. Specific examples are used for explaining the principles and implementations of this disclosure herein. The description of the above embodiments is only for helping understand the technical solutions and core ideas of the present disclosure. Those of ordinary skill in the art should understand that: the technical solutions recorded in the foregoing embodiments can be modified, or the partial features can be replaced with equivalent features. These modifications or replacements do not make the essence of the corresponding technical solutions depart from the scope of the technical solution of each embodiment of the present disclosure.

What is claimed is:

1. A display panel, comprising a circuit layer, a pixel layer disposed on the circuit layer, a color filter substrate disposed on one side of the pixel layer away from the circuit layer; wherein
the pixel layer comprises a plurality of sub-pixels, a first gap is formed between two of the sub-pixels adjacent to each other having different colors, and each of the sub-pixels includes a first main electrode splitting said one of the sub-pixels; and
the circuit layer comprises a plurality of shielding parts and a plurality of data lines, one of the shielding parts corresponds to the first gap, and each of the data lines is aligned to the first main electrode of the sub-pixels corresponding to the data lines; and
the color filter substrate comprises a plurality of color resist blocks with different colors, the color resist blocks correspond to the sub-pixels, a third gap is formed between two of the color resist blocks adjacent to each other, and a width of one of the shielding parts is greater than a width of the first gap and a width of the third gap corresponding to said one of the shielding parts.

2. The display panel according to claim 1, wherein each of the sub-pixels comprises a first sub-pixel portion and a second sub-pixel portion, a second gap is formed between the first sub-pixel portion and the second sub-pixel portion, and one of the shielding parts corresponds to the second gap.

3. The display panel according to claim 2, wherein a width of one of the shielding parts is greater than a width of the second gap corresponding to said one of the shielding parts.

4. The display panel according to claim 1, wherein each of the sub-pixels comprises a main electrode splitting said one of the sub-pixels, and the shielding parts correspond to the main electrode.

5. The display panel according to claim 4, wherein a width of one of the shielding parts is greater than a width of the main electrode corresponding to said one of the shielding parts.

6. The display panel according to claim 1, wherein a material of the shielding parts is an opaque metal.

7. The display panel according to claim 1, wherein each of the sub-pixels further comprises a first branch electrode and a second branch electrode disposed on two sides of the first main electrode, the first branch electrode and the second branch electrode both comprise a plurality of sub-branch electrodes, wherein an arrangement direction of the sub-branch electrodes of the first branch electrode is different from an arrangement direction of the sub-branch electrodes of the second branch electrode.

8. The display panel according to claim 1, wherein each of the sub-pixels further comprises a second main electrode, the second main electrode and the first main electrode are cross-arranged with each other, and the second main electrode split said one of the sub-pixels; and
the circuit layer further comprises a plurality of gate lines, each of the gate lines controls multiple of the sub-pixels, each of the gate lines is aligned to the second main electrode of the sub-pixels corresponding to said one of the gate lines.

9. A display panel, comprising a circuit layer and a pixel layer disposed on the circuit layer; wherein
the pixel layer comprises a plurality of sub-pixels, a first gap is formed between two of the sub-pixels adjacent to each other having different colors; and
the circuit layer comprises a plurality of shielding parts, and one of the shielding parts corresponds to the first gap.

10. The display panel according to claim 9, wherein the display panel further comprises:
a color filter substrate disposed on one side of the pixel layer away from the circuit layer, wherein the color filter substrate comprises a plurality of color resist blocks with different colors, the color resist blocks correspond to the sub-pixels, a third gap is formed between two of the color resist blocks adjacent to each other with different colors, and a width of one of the shielding parts is greater than a width of the first gap and a width of the third gap corresponding to said one of the shielding parts.

11. The display panel according to claim 9, wherein each of the sub-pixels comprises a first sub-pixel portion and a second sub-pixel portion, a second gap is formed between the first sub-pixel portion and the second sub-pixel portion, and one of the shielding parts corresponds to the second gap.

12. The display panel according to claim 11, wherein a width of one of the shielding parts is greater than a width of the second gap corresponding to said one of the shielding parts.

13. The display panel according to claim 9, wherein each of the sub-pixels comprises a main electrode splitting said one of the sub-pixels, and one of the shielding parts corresponds to the main electrode.

14. The display panel according to claim 13, wherein a width of one of the shielding parts is greater than a width of the main electrode corresponding to said one of the shielding parts.

15. The display panel according to claim 9, wherein a material of the shielding parts is an opaque metal.

16. The display panel according to claim 9, wherein each of the sub-pixels comprises a first main electrode splitting said one of the sub-pixels; and
the circuit layer further comprises a plurality of data lines, each of the data lines controls multiple of the sub-pixels, and each of the data lines is aligned to the first main electrode of the multiple of the sub-pixels corresponding to said one of the data lines.

17. The display panel according to claim 16, wherein each of the sub-pixels further comprises a first branch electrode and a second branch electrode disposed on two sides of the first main electrode, the first branch electrode and the second branch electrode both comprise a plurality of sub-branch electrodes, wherein an arrangement direction of the sub-branch electrodes of the first branch electrode is different from an arrangement direction of the sub-branch electrodes of the second branch electrode.

18. The display panel according to claim 17, wherein each of the sub-pixels further comprises a second main electrode, the second main electrode and the first main electrode are cross-arranged with each other, and the second main electrode splits said one of the sub-pixels; and
the circuit layer further comprises a plurality of gate lines, each of the gate lines controls multiple of the sub-pixels, each of the gate lines is aligned to the second main electrode of the sub-pixels corresponding to said one of the gate lines.

19. A display device, comprising a display panel provided with a circuit layer, and a pixel layer disposed on the circuit layer;
wherein the pixel layer comprises a plurality of sub-pixels, and a first gap is formed between two of the sub-pixels adjacent to each other having different colors; and
the circuit layer comprises a plurality of shielding parts, one of the shielding parts corresponds to the first gap.

20. The display device according to claim 19, wherein each of the sub-pixels comprises a first main electrode splitting said one of the sub-pixels; and
the circuit layer further comprises a plurality of data lines, each of the data lines controls multiple of the sub-pixels, each of the data lines is aligned to the first main electrode of the sub-pixels corresponding to said one of the data lines.
